(19) United States
(12) Patent Application Publication
(10) Pub. No.: US 2023/0243746 A1
(43) Pub. Date: Aug. 3, 2023

(54) Determination Of The Concentration Of One Or More Substances In A Fluid

(71) Applicant: Fenwal, Inc., Lake Zurich, IL (US)

(72) Inventors: Benjamin E. Kusters, Pleasnt Prairie, WI (US); James G. Madsen, Barrington, IL (US); Daniel R. Boggs, Libertyville, IL (US)

(21) Appl. No.: 18/101,275

(22) Filed: Jan. 25, 2023

Related U.S. Application Data
(60) Provisional application No. 63/305,395, filed on Feb. 1, 2022.

(51) Int. Cl. G01N 21/59; G01N 21/47

(52) U.S. Cl. CPC G01N 21/59; G01N 21/47

(57) ABSTRACT

An optical detection assembly for monitoring a fluid includes a light source, a light detector array, and a controller. The light source emits light into a fluid, while the light detector array includes a plurality of light detectors and receives light exiting the fluid. The controller determines the concentration of one or more substances in the fluid based on signals received from the light detector array. The assembly may include a second light detector array, with one array receiving transmitted light exiting the fluid, with the other receiving scattered light exiting the fluid. The assembly may include a vessel attachment receiving a portion of a vessel or a vessel connector connecting two vessels. The controller may be configured to determine the concentration of one or more substances in a fluid within a vessel received by a vessel attachment or in a fluid within a conduit defined by a vessel connector.

### CROSS-REFERENCE TO RELATED APPLICATIONS

This application claims the benefit of and priority of U.S. Provisional Patent Application Ser. No. 63/305,395, filed Feb. 1, 2022, the contents of which are incorporated by reference herein.

### BACKGROUND

### Field of the Disclosure

The present disclosure relates to optical monitoring of fluids. More particularly, the present disclosure relates to determination of the concentration of one or more substances in a fluid being optically monitored.

### Description of Related Art

It is known to employ an optical detection assembly to monitor the flow of blood, blood components, and other biological fluids through a fluid flow circuit to determine various characteristics of the flow. A typical optical detection assembly includes a light source (e.g., a laser or a light-emitting diode) configured to emit light into a fluid-containing vessel of the fluid flow circuit, with a light detector (e.g., a photodiode) configured to receive light exiting the vessel. The light detector transmits a signal to a controller based upon the light it has received, with the controller using the signal to determine one or more properties of the fluid.

A conventional optical detection assembly may have any of a number of possible shortcomings, depending on its exact configuration. For example, it is common for an optical detection assembly to monitor flow of a biological fluid through flexible plastic tubing of a fluid flow circuit. As shown in FIG. 1, when light “L” is incident upon plastic tubing “T”, the transport of light into the tubing lumen may vary according to Snell's Law depending on the refractive indices “n1” and “n2” of the materials and incident light angles “θ1” formed by the tubing surface. The refractive index n1 of air (which is approximately 1) and the refractive index n2 of plastic (which may typically be approximately 1.3 to 1.5) are quite different, and when combined with inconsistent formation of the tubing surface from procedure to procedure and, thus, varying incident angles θ1, light transport “θ2” into the tubing T will vary among procedures, leading to inconsistent measurements of fluid properties.

Another possible shortcoming is the configuration of the light detector of a conventional optical detection assembly, which is frequently a single photodiode. By such a configuration, only the amplitude of light exiting the vessel at a single location is known, whereas light transmitted through turbid media (e.g., blood or a blood component) will be dispersed, rather than exiting along a single path that can be fully received by a single photodiode.

On account of these and other shortcomings, conventional optical detection assemblies may not be optimal for determination of the properties of interest of a fluid being optically monitored.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, an optical detection assembly for monitoring a fluid in a vessel includes a light source, a light detector array, and a controller. The light source is configured and oriented to emit a light into a fluid in a vessel. The light detector array comprises a plurality of light detectors and is configured to receive at least a portion of the light exiting the vessel. The controller is configured to receive signals from the light detector array indicative of an intensity of said at least a portion of the light received by each one of said plurality of light detectors and determine a concentration of a substance in the fluid in the vessel based at least in part on said signals.

In another aspect, an optical detection assembly for monitoring a fluid in a vessel includes a light source, a light detector, a vessel attachment, and a controller. The light source is configured and oriented to emit a light into a fluid in a vessel, while the light detector is configured to receive at least a portion of the light exiting the vessel. The vessel attachment includes substantially parallel first and second faces, with the first face of the vessel attachment positioned facing the light source and oriented in a plane substantially orthogonal to a central axis of light emitted by the light source, and with the second face of the vessel attachment positioned facing the light detector. The vessel attachment defines a cavity positioned between the first and second faces and configured to receive at least a portion of the vessel, with an outer surface of said at least a portion of the vessel in contact with an adjacent surface of the cavity at locations in which the light emitted by the light source is configured to enter the vessel and exit the vessel. The controller is configured to receive a signal from the light detector indicative of an intensity of said at least a portion of the light received by the light detector and determine a concentration of a substance in the fluid in the vessel based at least in part on said signal.

In yet another aspect, an optical detection assembly for monitoring a fluid includes a light source, a light detector, a vessel connector, and a controller. The vessel connector includes substantially parallel first and second faces and defines a first cavity configured to receive at least a portion of a first vessel, a second cavity configured to receive at least a portion of a second vessel, and a conduit extending from the first cavity to the second cavity, with the conduit comprising substantially parallel first and second walls. The first face of the vessel connector is positioned facing the light source and oriented in a plane substantially orthogonal to a central axis of light emitted by the light source, while the second face of the vessel connector is positioned facing the light detector, with the first and second walls of the conduit being substantially parallel to the first and second faces of the vessel connector. The light detector is configured to receive at least a portion of the light emitted by the light source after that portion of the light has based through the first face of the vessel connector, through the first wall of the conduit, through a fluid in the conduit, through the second wall of the conduit, and through the second face of the vessel connector. The controller is configured to receive a signal from the light detector indicative of an intensity of the light received by the light detector and determine a concentration of a substance in the fluid in the conduit based at least in part on the signal.

These and other aspects of the present subject matter are set forth in the following detailed description of the accompanying drawings.

### BRIEF DESCRIPTION OF THE DRAWINGS

FIG. 1 is a diagrammatic view of light being transmitted through air into a plastic tubing of a conventional fluid flow circuit;

FIG. 2 is a perspective view of a vessel attachment of an optical detection assembly according to an aspect of the present disclosure, receiving a portion of a fluid-containing vessel;

FIG. 3 is an exploded view of the vessel attachment and vessel of FIG. 2;

FIG. 4 is a perspective view of the vessel attachment of FIGS. 2 and 3, incorporated into sensor housings of an optical detection assembly;

FIGS. 5 and 6 are diagrammatic views of light being transmitted through air, through the vessel attachment of FIGS. 2-4, and into a vessel received by the vessel attachment;

FIGS. 7A and 7B are perspective views of another embodiment of a vessel attachment and vessel according to an aspect of the present disclosure;

FIG. 7C is a cross-sectional view of the vessel attachment and vessel of FIG. 7B;

FIGS. 8A and 8B are perspective views of another embodiment of a vessel attachment and vessel according to an aspect of the present disclosure;

FIG. 8C is an end view of the vessel attachment and vessel of FIG. 8B;

FIGS. 9A and 9B are perspective view of another embodiment of a vessel attachment and vessel according to an aspect of the present disclosure;

FIG. 9C is an end view of the vessel attachment and vessel of FIG. 9B;

FIG. 10A is a perspective view of a vessel connector and a pair of vessels according to an aspect of the present disclosure;

FIG. 10B is a cross-sectional view of the vessel connector and vessels of FIG. 10A;

FIG. 10C is an end view of the vessel connector and vessels of FIGS. 10A and 10B;

FIG. 11 is a diagrammatic view of an optical detection assembly according to an aspect of the present disclosure, monitoring a fluid having a low cellular concentration;

FIG. 12 is a diagrammatic view of the optical detection assembly of FIG. 11, monitoring a fluid having a high cellular concentration;

FIG. 13 is a chart illustrating the responses of a light detector array when monitoring fluids having different cellular concentrations;

FIG. 14 is a chart illustrating the unfiltered response of a light detector array when monitoring a fluid having a high cellular concentration;

FIG. 15 is a chart illustrating the light detector array response of FIG. 14 after application of a filter to the data;

FIG. 16 is a chart illustrating the unfiltered response of a light detector array when monitoring a fluid having a low cellular concentration;

FIG. 17 is a chart illustrating the light detector array response of FIG. 16 after application of a filter to the data;

FIG. 18 is a chart illustrating an average of 1,000 responses of a light detector array when monitoring a fluid having a low cellular concentration;

FIG. 19 is a chart illustrating an average of 1,000 responses of a light detector array when monitoring a fluid having a high cellular concentration;

FIG. 20 is a chart illustrating the average light detector array response of FIG. 18, after fitting a function by non-linear regression to the data;

FIG. 21 is a chart illustrating the average light detector array response of FIG. 19, after fitting a function by non-linear regression to the data;

FIGS. 22-27 are charts illustrating the results of various approaches to correlating light detector array responses to the platelet concentration of a fluid;

FIGS. 28 and 29 are charts illustrating approaches to correlating the width of light distribution to cellular concentration of a fluid;

FIG. 30 is a chart illustrating the results of various approaches to correlating the width of light distribution to cellular concentration of a fluid;

FIG. 31 is a perspective view of an exemplary light detector array suitable for use in optical detection assemblies according to the present disclosure;

FIG. 32 is a perspective view of the light detector array of FIG. 31, with an associated fluid-filled vessel positioned adjacent to the array and light being directed through the vessel and to the array;

FIG. 33 is a perspective view of a light source and two sensors of an optical detection assembly according to an aspect of the present disclosure, along with a fluid-filled vessel to be monitored;

FIG. 34 is a cross-sectional view of the light source, sensors, and vessel of FIG. 33;

FIG. 35 is a perspective view of an optical detection assembly according to an aspect of the present disclosure, with a lid thereof in an open position;

FIG. 36 is a perspective view of the optical detection assembly of FIG. 35, with the lid in a closed position; and

FIG. 37 is a cross-sectional view of the optical detection assembly of FIG. 36.

### DESCRIPTION OF THE ILLUSTRATED EMBODIMENTS

The embodiments disclosed herein are for the purpose of providing a description of the present subject matter, and it is understood that the subject matter may be embodied in various other forms and combinations not shown in detail. Therefore, specific designs and features disclosed herein are not to be interpreted as limiting the subject matter as defined in the accompanying claims.

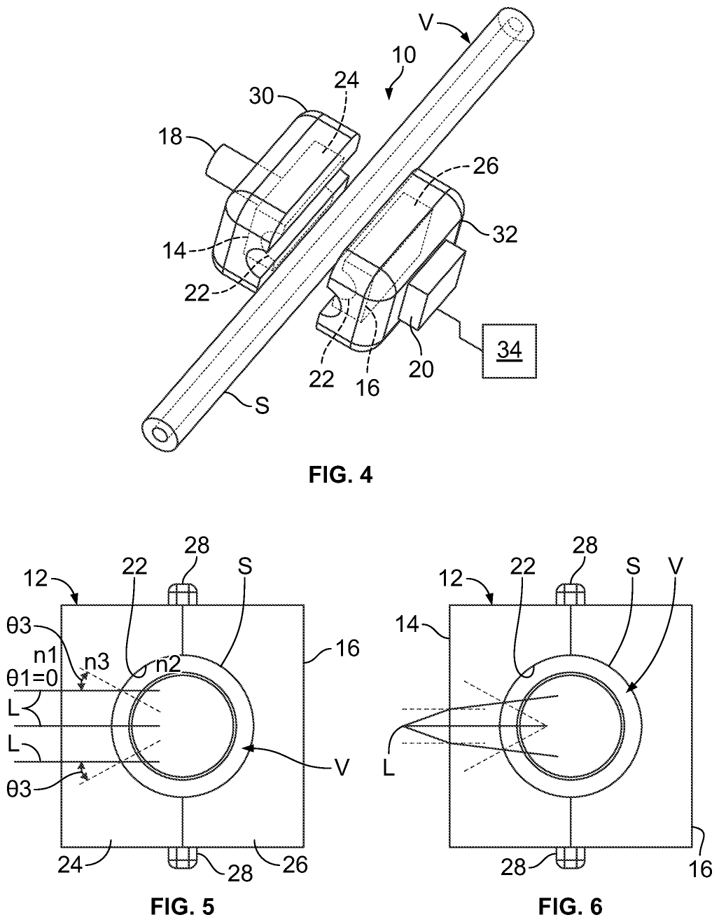

An optical detection assembly embodying aspects of the present disclosure and components thereof are shown in FIGS. 2-6. The optical detection assembly 10 (FIG. 4) is shown in isolation, but it should be understood that optical detection assemblies according to the present disclosure would typically be incorporated into a biological fluid processing system, such as one of the type described in U.S. Pat. No. 10,890,524 (which is hereby incorporated herein by reference), or any other system in which a fluid in a vessel is to be optically monitored. Additionally, while optical detection assemblies of the type described herein may be used to replace a conventional optical detection assembly, it should be understood that optical detection assemblies of the type described herein may provide the basis for new systems and optical monitoring applications that would not be possible with a conventional optical detection assembly.

The illustrated optical detection assembly 10 includes a light-transmissive vessel attachment or fixture or clip 12. The vessel attachment 12 includes substantially parallel first and second faces 14 and 16. The first face 14 is configured to face a light source 18 of the optical detection assembly 10 (FIG. 4), while the second face 16 is configured to face a light detector 20 of the optical detection assembly 10. While the vessel attachment 12 is illustrated in FIG. 2 as being a cube or cuboid or rectangular prism, it should be understood that its shape may vary without departing from the scope of the present disclosure, provided that the first and second faces 14 and 16 are substantially parallel.

The vessel attachment 12 defines a cavity 22 positioned between the first and second faces 14 and 16. As shown in FIGS. 2-6, the cavity 22 receives a portion of a fluid-containing vessel “V”. As will be explained in greater detail, at least a portion of the surface of the cavity 22 is configured to be directly in contact with an adjacent outer surface “S” of the vessel V. The configuration of the vessel V may vary without departing from the scope of the present disclosure, such that the configuration of the cavity 22 may also vary without departing from the scope of the present disclosure. In an exemplary embodiment, which is shown in FIGS. 2-6, the vessel V is configured as a conventional plastic tube T of a fluid flow circuit. To accommodate such a vessel V, the illustrated cavity 22 is substantially cylindrical, with a central axis extending parallel to the planes in which the first and second faces 14 and 16 are defined.

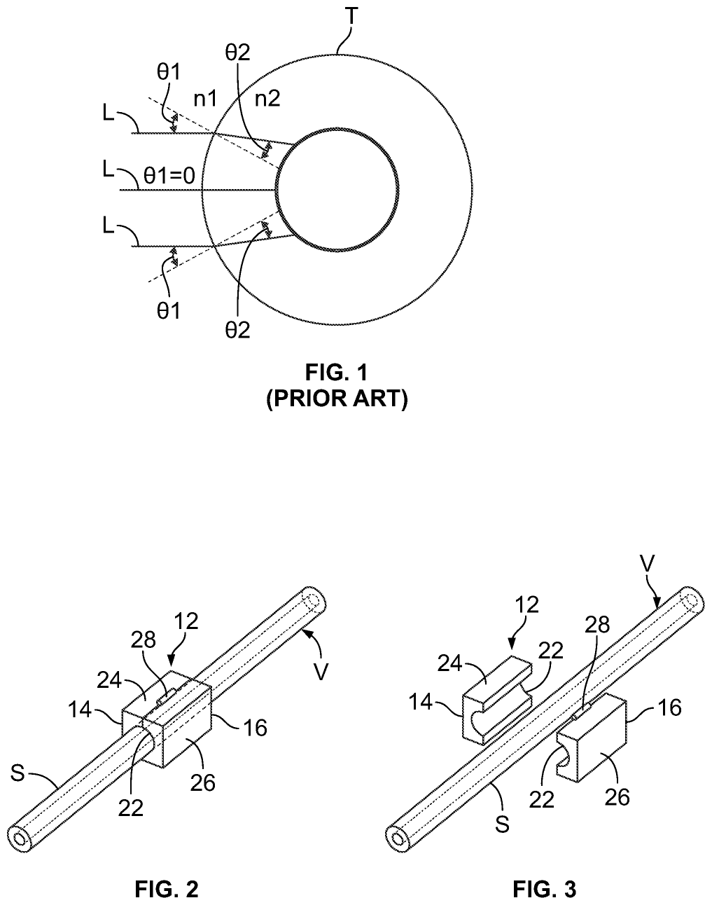

As explained above, the refractive indices of air and plastic are significantly different, which leads to light L being transmitted into a conventional plastic tube T as shown in FIG. 1, with substantially parallel rays of collimated light being bent or refracted along paths that are not parallel when the light L enters the tube T. FIG. 5 illustrates the transfer of collimated light L from a light source into and through the first face 14 of the vessel attachment 12 and into the vessel V, with the individual rays of light remaining parallel as they pass into and through the vessel V, even at a vessel attachment-vessel interface oriented at an angle “θ3”. Three characteristics of the vessel attachment 12 make such light transfer possible. First, the first face 14 of the vessel attachment 12 is oriented in a plane substantially orthogonal to the path of the light L from the light source 18 (i.e., 01 is zero), such that the light is not bent or refracted when moving from the air into the vessel attachment 12 (which will typically have a refractive index “n3” that is different from the refractive index n1 of air). While FIG. 5 illustrates the light as passing through air before reaching the first face 14 of the vessel attachment 12, it should be understood that the light L may pass through any other light-transmissive material before reaching the first face 14 of the vessel attachment 12, on account of any difference in refractive index being nullified by the orientation of the first face 14 of the vessel attachment 12. It is also within the scope of the present disclosure for the light source 18 to be in direct contact with the first face 14 of the vessel attachment 12, with there being no intervening medium through which the light L must pass before reaching the vessel attachment 12.

The second characteristic of the vessel attachment 12 allowing for improved light transmission is the material composition of the vessel attachment 12. As explained above, the significant difference in the refractive indices of air and plastic causes light to bend or refract when moving from air into a plastic tube T at an angle θ1 to the outer surface of the tube T. However, the vessel attachment 12 is formed of a material having a refractive index n3 that is the same or at least substantially the same as the refractive index n2 of the vessel V, such that the light is not bent or refracted when moving from the vessel attachment 12 to the vessel V at an angle θ3 to the outer surface S of the vessel V and from the vessel V to the vessel attachment 12 at an angle to the surface of the cavity 22. This is true of both collimated light (FIG. 5) and diffuse light (FIG. 6) emitted by a light source 18. Indeed, while light incident upon the first face 14 of the vessel attachment 12 at an angle will be bent or refracted (due to the different refractive indices n1 and n3), the bent or refracted light passing through the vessel attachment 12 will not be further bent or refracted when moving from the vessel attachment 12 into the vessel V (as shown in FIG. 6) or when the light subsequently exits the vessel V and reenters the vessel attachment 12.

As the material composition and, thus, the refractive index n2 of the vessel V may vary without departing from the scope of the present disclosure, the material composition of the vessel attachment 12 may similarly vary so as to have a refractive index n3 that is the same or at least substantially the same as the refractive index n2 of the vessel V. In an exemplary embodiment, the vessel V is formed of plasticized polyvinyl chloride (“PVC”), with the vessel attachment 12 being formed of plastic or quartz or some other material having a refractive index n3 that is the same or at least substantially the same as the refractive index of plasticized PVC.

The third characteristic of the vessel attachment 12 allowing for improved light transmission is the configuration of the cavity 22, which places at least a portion of the surface of the cavity 22 into direct contact with the outer surface S of the vessel V. As explained above, the material composition of the vessel attachment 12 addresses the significant difference in the refractive indices of air and the material forming the vessel V (by providing a refractive index n3 more similar to the refractive index n2 of the material of the vessel V). However, the similar refractive indices of the materials forming the vessel attachment 12 and vessel V is most advantageous when the surface of the cavity 22 is in direct contact with the outer surface S of the vessel V. Direct contact may be achieved by any of a number of suitable approaches, including (for example): solvent bonding, adhesive bonding, and implementation of an interference fit. If the surfaces of the cavity 22 and the vessel V are not in direct contact, there will be air between the surfaces, such that light must pass through the vessel attachment 12 and then through the air (which has a refractive index n1 that may be significantly different from the refractive indices n2 and n3 of the materials forming the vessel V and the vessel attachment 12, respectively), with the light bending or refracting at an angled interface between adjacent media.

In the illustrated embodiment, the entire perimeter or outer surface S of the vessel V contacts the surface of the cavity 22, with no air therebetween, though it should be understood that such a configuration is not necessary. Indeed, light may be properly transmitted between the vessel attachment 12 and the vessel V provided that there is direct contact between the surface of the cavity 22 and the outer surface S of the vessel V at the locations in which light is transitioning from one of the structures to the other (i.e., where light exits the vessel attachment 12 and enters the vessel V and where light exits the vessel V and reenters the vessel attachment 12). For example, in the configuration shown in FIG. 5, light would not be expected to transition from one of the vessel attachment 12 and the vessel V to the other at the top and bottom of the vessel V, such that there may be an air gap or separation between the top and bottom of the vessel V and the adjacent surface of the vessel attachment 12 without impacting the transmission of light through the assembly.

It will, thus, be seen that the configuration of the vessel attachment 12 will eliminate the inconsistent light transport to a fluid of interest within the vessel V as occurs in conventional optical detection assemblies (FIG. 1), producing optical systems with more accurate and consistent results. Even when light L is incident upon the first face 14 of the vessel attachment 12 at an angle and bends or refracts upon entering the vessel attachment 12 (as shown in FIG. 6), the transport of light L into the vessel attachment 12 is expected to be consistent according to Snell's Law because the surface angle of the first face 14 of the vessel attachment 12 will not vary among procedures. Indeed, regardless of the nature of the light source 18, if the vessel V is placed within the vessel attachment 12 and directly in contact with the vessel attachment material without significant imperfections such as air gaps, then according to Snells' Law the light L will continue on the same path as it passes into the vessel V from the vessel attachment 12 because the refractive indices n3 and n2 of the vessel attachment 12 and vessel V are designed to be the same or very similar.

The vessel attachment 12 may be formed as a unit or single piece or may be defined by two or more pieces, as shown in FIGS. 2-6. In the illustrated embodiment, the vessel attachment 12 is comprised of a first piece 24 and a similarly configured second piece 26, with each defining a portion of the cavity 22. While FIGS. 2-6 show similarly configured first and second pieces 24 and 26 each defining half of the cavity 22, it should be understood that the pieces of the vessel attachment 12 may be differently configured without departing from the scope of the present disclosure, which may include one piece defining more of the cavity 22 than the other piece. It is also contemplated that the vessel attachment 12 may be comprised of more than two pieces.

In the illustrated embodiment, the two pieces 24 and 26 of the vessel attachment 12 are separate (FIG. 3), with one or more clasps or other fasteners 28 being provided to enable the pieces 24 and 26 of the vessel attachment 12 to be secured together, with a portion of the vessel V being clamped within the cavity 22 of the vessel attachment 12. Alternatively, the two pieces 24 and 26 may be joined at a hinge, rather than being separately provided, with at least a portion of one piece being movable with respect to at least a portion of the other piece to allow a vessel V to be placed between the two pieces 24 and 26, followed by the pieces 24 and 26 being moved and secured to each other.

FIG. 4 illustrates separate vessel attachment pieces 24 and 26 incorporated into first and second sensor housings 30 and 32 of an optical detection assembly 10. In the illustrated embodiment, the first vessel attachment piece 24 (defining the first face 14 of the vessel attachment 12) is incorporated into or associated with the first sensor housing 30, while the second vessel attachment piece 26 (defining the second face 14 of the vessel attachment 12) is incorporated into or associated with the second sensor housing 32. The light source 18 is incorporated into or associated with the first sensor housing 30 and oriented to emit light toward the first face 14 of the first vessel attachment piece 24 along a central axis substantially orthogonal to the first face 14. To allow light from the light source 18 to reach the first vessel attachment piece 24, the first sensor housing 30 may define an aperture to accommodate the light emitted by the light source 18. Alternatively, at least a portion of the first sensor housing 30 positioned between the light source 18 and the first vessel attachment piece 24 may be formed of a light-transmissive material. As explained above, the nature of the light source 18 and the nature of the media (whether air or a physical material) through which light from the light source 18 passes before reaching the first face 14 of the first vessel attachment piece 24 may vary without departing from the scope of the present disclosure.

The light detector 20 is incorporated into or associated with the second sensor housing 32. To allow light exiting the vessel V and the second face 16 of the second vessel attachment piece 26 to reach the light detector 20, the second sensor housing 32 may define an aperture to accommodate the light. Alternatively, at least a portion of the second sensor housing 32 positioned between the second vessel attachment piece 26 and the light detector 20 may be formed of a light-transmissive material.

As shown in FIG. 4, the first and second sensor housings 30 and 32 may be spaced apart to allow a portion of a vessel V to be positioned between the two vessel attachment pieces 24 and 26. When the vessel V is properly positioned, the first and/or second sensor housings 30 and 32 may be moved to bring the first and second vessel attachment pieces 24 and 26 into contact, thereby clamping a portion of the vessel V within the cavity 22 of the vessel attachment 12. A movable sensor housing may be moved manually or automatically, such as by operation of a motor or the like.

When the vessel attachment 12 is assembled and a fluid of interest is present in the portion of the vessel V received by the vessel attachment 12, the light source 18 may emit light into and through the first face 14 of the vessel attachment 12 and into the vessel V, as shown in FIGS. 5 and 6. At least a portion of the light exits the vessel V after passing through the fluid and reenters the vessel attachment 12, where it is transmitted out of the vessel attachment 12 via the second face 16 and received by the light detector 20. The light detector 20 may be variously configured without departing from the scope of the present disclosure. In one exemplary embodiment, the light detector 20 may be provided according to conventional design (e.g., being configured as a single photodiode). In another exemplary embodiment, the light detector 20 may be configured as a light detector array of the type that will be described in greater detail herein.

Regardless of the particular configuration of the light detector 20, it transmits one or more signals to a controller 34, which determines one or more properties of the fluid in the vessel V (e.g., the concentration of a substance, such as platelets, in the fluid) based at least in part on the signal(s). The controller 34 may be variously configured without departing from the scope of the present disclosure. In one embodiment, the controller 34 may include a microprocessor (which, in fact may include multiple physical and/or virtual processors). According to other embodiments, the controller 34 may include one or more electrical circuits designed to carry out the actions described herein. In fact, the controller 34 may include a microprocessor and other circuits or circuitry. In addition, the controller 34 may include one or more memories. The instructions by which the microprocessor is programmed may be stored on the memory associated with the microprocessor, which memory/memories may include one or more tangible non-transitory computer readable memories, having computer executable instructions stored thereon, which when executed by the microprocessor, may cause the microprocessor to carry out one or more actions as described herein. In one exemplary embodiment, the controller 34 comprises a main processing unit (MPU), which can comprise, e.g., a PENTIUM® type microprocessor made by Intel Corporation, although other types of conventional microprocessors can be used.

It will be seen that, in the optical detection assembly 10 of FIG. 4, the vessel attachment 12 is incorporated into the hardware of a fluid processing system. In alternative embodiments, the vessel attachment 12 may instead be applied to the vessel V of an individual fluid flow circuit or disposable kit during manufacturing. Attaching the vessel attachment 12 directly to a vessel V (as shown in FIG. 2) would increase the cost of the associated fluid flow circuit or disposable kit, but better ensures a sound fit with the vessel V and optimal optical clarity of the vessel attachment material, as re-use may lead to scratches or other imperfections of the vessel attachment 12. If the vessel attachment 12 is to be fixedly secured to a vessel V, it may be advantageous to bond the vessel attachment 12 to the vessel V (e.g., via a solvent bond or an adhesive bond) to further improve communication of the materials of the vessel attachment 12 and the vessel V (i.e., to avoid air gaps). On the other hand, incorporation of the vessel attachment 12 into the hardware (as shown in FIG. 4) is more cost-effective and may be advantageous, provided that the optical detection assembly 10 can enclose and mate with the vessel V of a fluid flow circuit or disposable kit consistently.

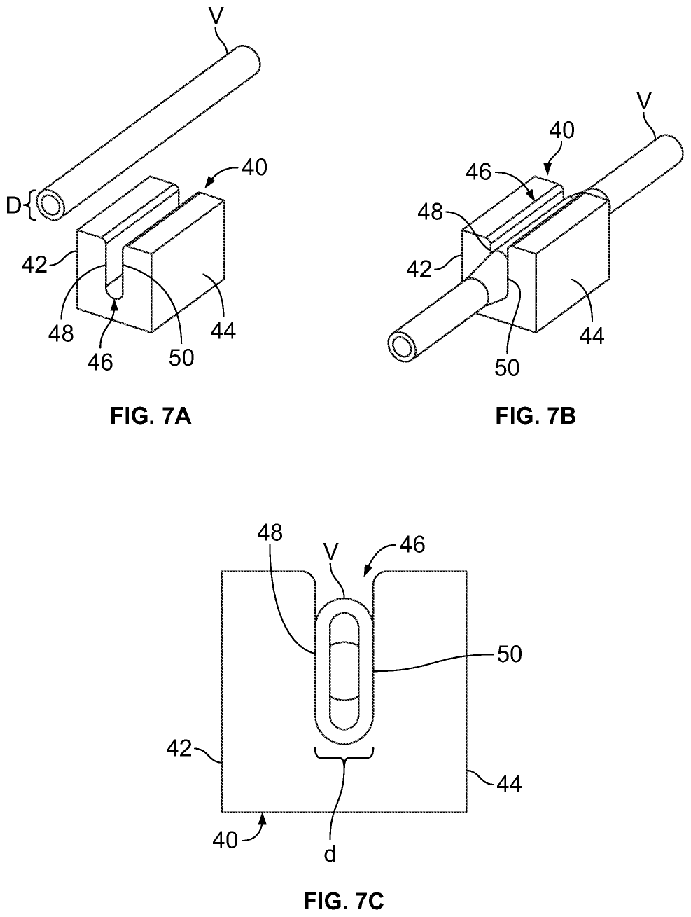

It should be understood that the vessel attachment 12 of FIGS. 2-6 is merely exemplary and that vessel attachments according to the present disclosure may be differently configured. For example, FIGS. 7A-7C illustrate another exemplary embodiment of a vessel attachment 40. The vessel attachment 40 of FIGS. 7A-7C is illustrated as a single-piece component, but may be comprised of two or more pieces. Similar to the embodiment of FIGS. 2-6, the vessel attachment 40 of FIGS. 7A-7C has substantially parallel first and second faces 42 and 44, with the first face 42 configured to be positioned to face a light source and the second face 44 configured to be positioned to face a light detector. As in the embodiment of FIGS. 2-6, the first face 42 may be oriented in a plane substantially orthogonal to a central axis of light emitted by the light source, with the vessel attachment 40 optionally formed of a material having a refractive index substantially the same as the refractive index of the material forming the associated vessel V.

While the vessel attachment 12 of FIGS. 2-6 defines a cavity 22 configured to match the shape of a portion of a vessel V received by the cavity 22 (e.g., by being configured as a cylinder), the vessel attachment 40 of FIGS. 7A-7C instead defines a cavity 46 configured to deform the portion of the vessel V it receives. In particular, the cavity 46 of the vessel attachment 40 of FIGS. 7A-7C is defined by substantially parallel first and second walls 48 and 50 that are separated by a distance “d” (FIG. 7C) that is less than an outer dimension or diameter “D” (FIG. 7A) of the portion of the vessel V received by the cavity 46. Thus, in order to mount the vessel V within the cavity 46, the vessel V must be pinched or squeezed or otherwise deformed before pressing it into the cavity 46. The exact distance d between the first and second walls 48 and 50 may vary without departing from the scope of the present disclosure, but it should be selected such that an associated vessel V may be positioned therein without the vessel V being pinched or squeezed shut.

The cavity 46 retains the received portion of the vessel V in its deformed state, which forces that portion of the vessel V to have a shape that is more advantageous for optical monitoring of a fluid within the vessel V. More particularly, as best shown in FIG. 7C, the received portion of the vessel V bears against the first and second cavity walls 48 and 50, which forces opposing sides of the vessel V to conform to the substantially parallel orientations of the cavity walls 48 and 50. This effectively converts the vessel surfaces through which light from an associated light source passes to be substantially parallel to each other and to the first and second faces 42 and 44 of the vessel attachment 40 (and substantially orthogonal to a central axis of the light emitted by the light source). As explained above, presenting a vessel surface that is substantially orthogonal to the central axis of light emitted by the light source prevents refraction as light from the light source passes through the first face 42 of the vessel attachment 40 to reach the vessel V and as that light passes from the opposite side of the vessel V back into the vessel attachment 40 and continues toward the second face 44 of the vessel attachment 40.

As in the embodiment of FIGS. 2-6, it may be advantageous for the vessel attachment 40 of FIGS. 7A-7C to be formed of a material having a refractive index that is substantially the same as the refractive index of the material forming the vessel V to further reduce refraction during optically monitoring of fluid within the vessel V.

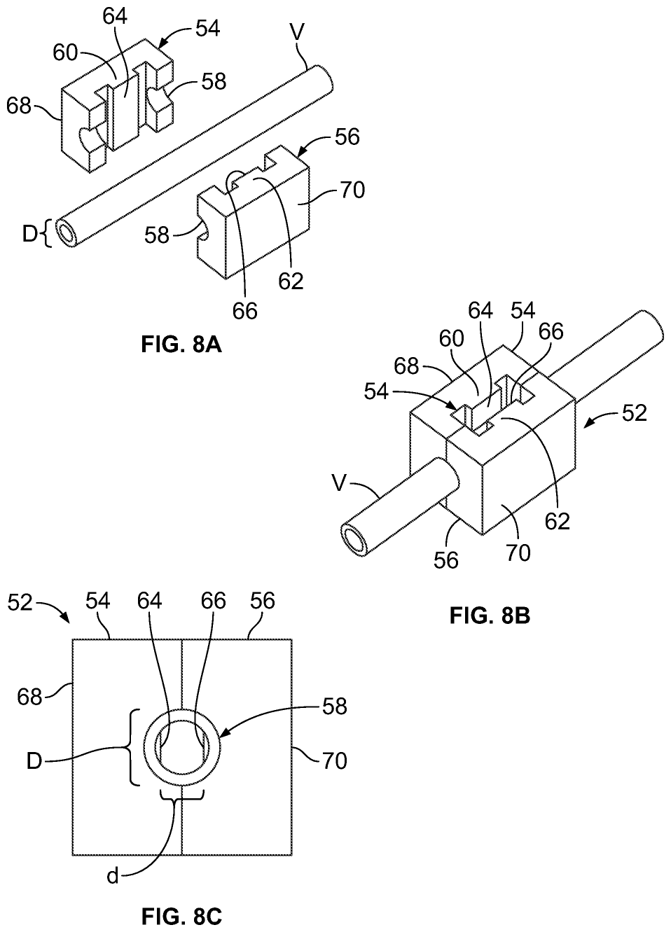

FIGS. 8A-8C illustrate a variation of the vessel attachment 40 of FIGS. 7A-7C. While the vessel attachment 40 of FIGS. 7A-7C is configured as a single-piece component, the vessel attachment 52 of FIGS. 8A-8C is provided in two pieces 54 and 56. In the illustrated embodiment, the vessel attachment 52 is comprised of a first piece 54 and a similarly configured second piece 56, with each defining a portion of the cavity 58. While FIGS. 8A-8C show similarly configured first and second pieces 54 and 56 each defining half of the cavity 58, it should be understood that the pieces of the vessel attachment 52 may be differently configured without departing from the scope of the present disclosure, which may include one piece defining more of the cavity 58 than the other piece. It is also contemplated that the vessel attachment 52 may be comprised of more than two pieces.

In the illustrated embodiment, the facing surfaces of the two pieces 54 and 56 of the vessel attachment 52 provide protrusions 60 and 62, with the protrusion 60 of the first piece 54 providing a first cavity wall 64 and the protrusion 62 of the second piece 56 providing a second cavity wall 66. When the two pieces 54 and 56 are joined or connected (as shown in FIGS. 8B and 8C), the protrusions 60 and 62 are aligned to define cavity walls 64 and 66 that are separated by a distance d that is less than an outer dimension or diameter D of the portion of the vessel V received by the cavity 58 (FIG. 8C). As described above with regard to the embodiment of FIGS. 7A-7C, this configuration forces the vessel V to present light-receiving surfaces that are substantially parallel to the first and second faces 68 and 70 of the vessel attachment 52 and substantially orthogonal to a central axis of light emitted by an associated light source, which reduces the degree of refraction as light is transmitted through fluid in the deformed portion of the vessel V positioned within the cavity 58.

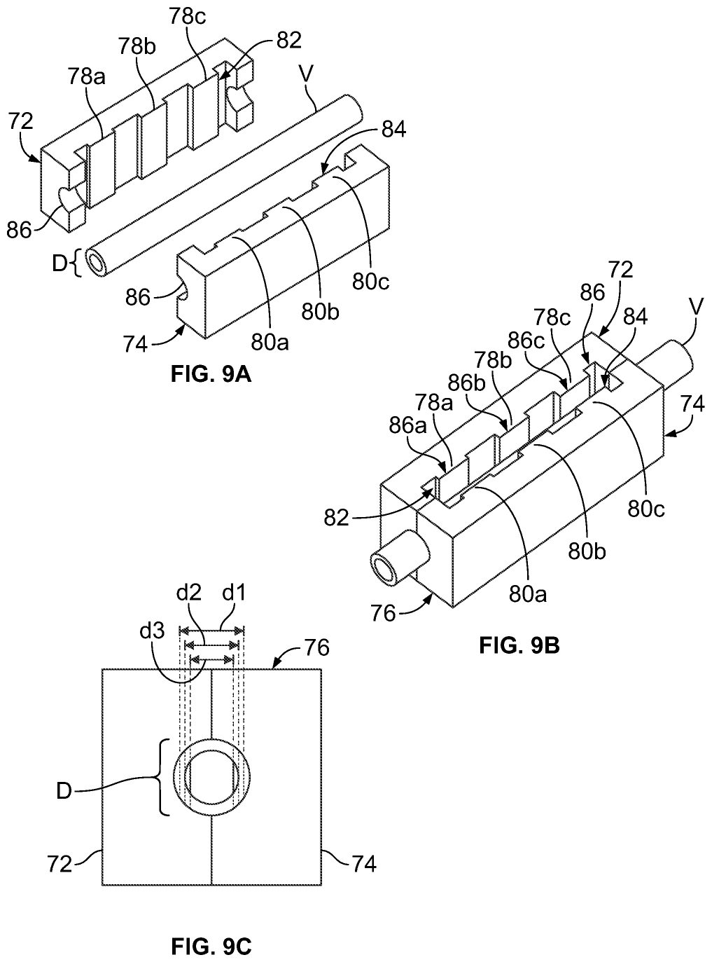

FIGS. 9A-9C illustrate a variation of the vessel attachment 52 of FIGS. 8A-8C. In the embodiment of FIGS. 9A-9C, the facing surfaces of the first piece 72 and the second piece 74 of the vessel attachment 76 each provide a plurality of protrusions 78a, 78b, 78c, 80a, 80b, and 80c. FIGS. 9A and 9B illustrate each piece 72, 74 as having three protrusions, but it should be understood that each piece 72, 74 may have two protrusions or more than three protrusions. Each protrusion is configured to be aligned with a different one of the protrusions of the other piece of the vessel attachment 76, with each aligned pair of protrusions providing a section of first and second cavity walls 82 and 84.

The protrusions are configured such that, when the two pieces 72 and 74 of the vessel attachment 76 are attached or connected or otherwise associated together, each pair of protrusions are separated by a different distance, each of which is less than an outer dimension or diameter D of the portion of the vessel V received within the cavity 86. In the illustrated embodiment, the first section 86a of the cavity 86 has first and second walls 82 and 84 separated by a relatively great distance “d1” (to present a “wide” optical pathlength), the second section 86b of the cavity 86 has first and second walls 82 and 84 separated by a smaller distance “d2” (to present an “intermediate” optical pathlength), and the third section 86c of the cavity 86 has first and second walls 82 and 84 separated by an even smaller distance “d3” (to present a “narrow” optical pathlength).

The vessel attachment 76 may be positioned so as to selectively align one of the pairs of protrusions with an associated light source and light detector, effectively selecting an optical pathlength for light being transmitted through fluid within the vessel V. In yet another embodiment, an optical detection assembly may be provided with a plurality of pairs of light source and light detectors, with each pair aligned with a different section of the cavity 86 to monitor fluid in the vessel V at different optical pathlengths. In either case, this may render the vessel attachment 76 more versatile and suitable for use with fluids and/or vessels that are best monitored at different optical pathlengths. For example, when monitoring a high concentration fluid, it may be advantageous to employ a relatively short optical pathlength because the large number of particles in the fluid may inhibit successful light transmission measurement. On the other hand, when a particle of interest is present in a smaller concentration, a longer optical pathlength may be advantageous in order to better ensure that a detectable transmission measurement is achieved.

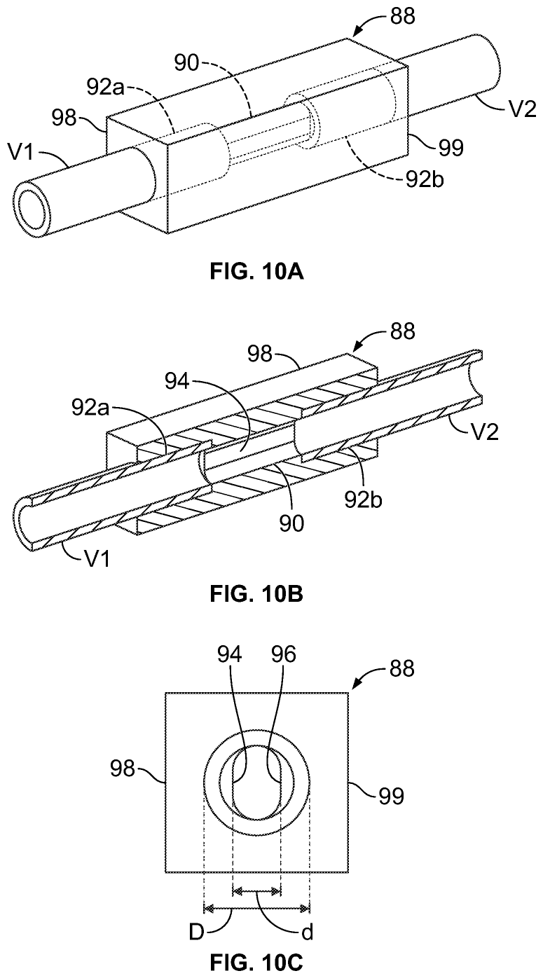

FIGS. 10A-10C illustrate a vessel connector 88, which is an alternative to the vessel attachments of FIGS. 2-9C. While a vessel attachment is configured to improve optical monitoring of a fluid within a vessel V, the vessel connector 88 instead defines a conduit 90 creating fluid communication between a pair of vessels “V1” and “V2”, with fluid in the conduit 90 (rather than in either vessel V1, V2) being optically monitored by a light source and light detector of the type described herein.

More particularly, the vessel connector 88 defines a first cavity 92a configured to receive an end of a first vessel V1 and a second cavity 92b configured to receive an end of a second vessel V2. FIGS. 10A-10C illustrate a pair of similarly configured, tubular vessels V1 and V2, but it should be understood that the vessels may be differently configured (including being differently configured from each other) without departing from the scope of the present disclosure, with each cavity of the vessel connector 88 being configured to conform to the shape of the associated vessel.

A conduit 90 is defined between the first and second cavities 92a and 92b to place the cavities 92a and 92b into fluid communication with each other. Similar to the cavities defined by the vessel attachments of FIGS. 7A-9C, the conduit 90 is defined in part by first and second walls 94 and 96, which are substantially parallel to each other and to first and second faces 98 and 99 of the vessel connector 88. As with the previously described vessel attachments, the first face 98 of the vessel connector 88 is positioned to face a light source, while the second face 99 is positioned to face a light detector, with the first face 98 oriented in a plane substantially orthogonal to a central axis of light emitted by the light source. It may be advantageous for the conduit 90 to have a smaller cross-sectional surface area than each lumen of the associated vessels V1 and V2 in order to ensure that the conduit 90 is completely filled with fluid, rather than allowing for there to be air in the conduit 90 (which could affect optical monitoring of the fluid). This may include the first and second conduit walls 94 and 96 being separated by a distance d less than the diameter D of at least one of (but more advantageously both of) the cavities 92a and 92b.

In use, light from the light source strikes the first face 98 of the vessel connector 88 and is transmitted through the body of the vessel connector 88 (which may be formed of any suitable light-transmissive material) until it at least a portion of the light reaches the first wall 94 of the conduit 90. The light passes through the first wall 92 and through fluid within the conduit 90, which will typically be flowing from one vessel to the other. The light exiting the fluid will pass through the second wall 96 of the conduit 90, through the body of the vessel connector 88, and then out through the second face 99 of the vessel connector 88 to be received by the light detector. As is the case with the vessel attachments of FIGS. 7A-9C, the substantially parallel walls 94 and 96 of the conduit 90 allow for improved optical monitoring of fluid by simulating the flat faces of a cuvette, while allowing for a flow of fluid to be analyzed, unlike a cuvette (which is a container for a sample of fluid, rather than a vessel or conduit through which fluid may flow).

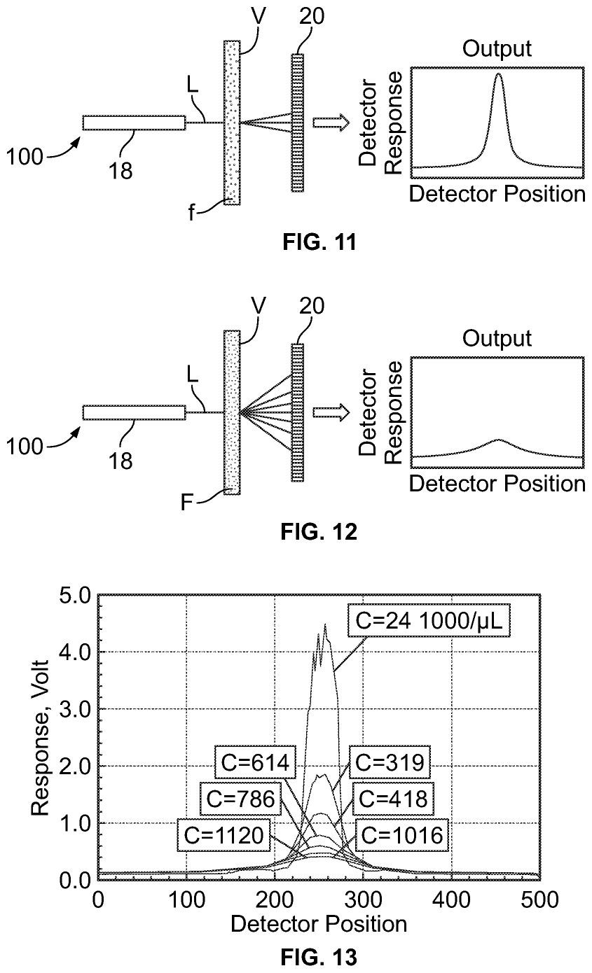

Turning back now to the light detector 20, as noted above, it is within the scope of the present disclosure for it to be configured as a light detector array, as shown in FIGS. 11 and 12. FIGS. 11 and 12 illustrate a light source 18, a vessel V, and a light detector array 20, omitting a vessel attachment or vessel connector. While it should be understood that the optical detection assembly 100 of FIGS. 11 and 12 may include a vessel attachment or vessel connector according to the present disclosure, it will be seen that the principles illustrated in FIGS. 11 and 12 are not limited to optical detection assemblies including a vessel attachment or vessel connector, but may be employed in a variety of differently configured systems. Additionally, while FIGS. 11 and 12 illustrate a fluid within a vessel V being monitored, it should be understood that the principles illustrated in FIGS. 11 and 12 are applicable to a fluid being monitored in a conduit 90 of the type defined by a vessel connector 88 according to the present disclosure.

In the optical detection assembly 100 of FIGS. 11 and 12, light L emitted by a light source 18 (which may be variously configured without departing from the scope of the present disclosure) enters and then exits a vessel V after passing through a fluid within the vessel V. FIGS. 11 and 12 illustrate transmitted light exiting the vessel V, with the light detector array 20 positioned and oriented to receive at least a portion of the transmitted light. It should be understood that at least a portion of the light emitted into the vessel V may be scattered by a component of the fluid, rather than being transmitted through the fluid. Accordingly, while FIGS. 11 and 12 illustrate the light detector array 20 as a transmission sensor positioned 180° from the light source 18 with respect to the vessel V, it should be understood that the light detector array may instead be configured as a side-scatter sensor positioned and oriented (e.g., 90° from the light source 18) so as to receive scattered light exiting the vessel V. As will be described in greater detail, it is also within the scope of the present disclosure for a pair of light detector arrays to be provided, with one serving as a transmission sensor and the other serving as a side-scatter sensor to allow for detection of both transmitted and scattered light exiting the vessel V.

Regardless of the particular position and orientation of the light detector array 20, it is comprised of a plurality of light detectors or light-sensing elements (e.g., 256 photodiodes in a linear array). As explained above, light exiting a turbid media (such as blood or a blood component) will be dispersed, such that the light may be detected at multiple positions, rather than at a single location by a single light detector (e.g., an individual photodiode). It has been found that different fluids (e.g., ones having different concentrations of a target substance) may result in emerging light beams having different dispersion patterns. For example, FIG. 11 illustrates a fluid “f” having a relatively low concentration of a platelets, while FIG. 12 illustrates a fluid “F” having a higher concentration of platelets. The light L (which may be a narrowly focused laser beam, for example) transmitted through the fluid in the vessel V is dispersed, with different individual light detectors receiving different portions of the transmitted light.

A controller (not illustrated) associated with the light detector array 20 receives signals from each of the individual light detectors of the light detector array 20, with each signal being indicative of the intensity of light received by the individual light detector that transmitted the signal to the controller. FIGS. 11 and 12 include charts that illustrate the intensity of the signal received by the controller from each individual light detector, with the results ordered by the relative positions of the individual light detectors (i.e., the signal from the light detector at one end of the light detector array 20 is presented at the left end of each chart, with the signal from the adjacent light detector being presented just to the right of the signal from the first light detector and so on until the signal from the light detector at the other end of the light detector array 20 is presented at the right end of each chart). As can be seen in FIGS. 11 and 12, the light detectors at the center of the light detector array 20 will tend to receive the most intense light, with the light detectors at each end of the light detector array 20 receiving little to no light.

In the illustrated embodiment, the platelets cause light to scatter, rather than being transmitted straight through the fluid and vessel V (along its initial path). As there are more platelets in the fluid F of FIG. 12, there is more scattering of the light, with more individual light detectors receiving at least some of the light, though with a relatively low maximum intensity compared to the maximum intensity of the light received by an individual light detector in FIG. 11. Stated differently, light passing through the less concentrated fluid f of FIG. 11 is narrowly distributed or dispersed, while light passing through the more highly concentrated fluid F of FIG. 12 is more widely or broadly distributed or dispersed. Thus, by providing a light detector array 20, the intensity of light received by multiple individual light detectors (i.e., the light distribution) may be assessed to determine one or more properties of a subject fluid, such as a concentration of a substance (e.g., platelets) in the fluid. This may allow for improved measurement accuracy compared to conventional optical detection assemblies having a single light detector and a controller configured only to assess the intensity of light received by the single light detector.

FIG. 13 shows a typical raw light intensity output I_{R}(p) of a light detector array 20 having 500 individual light-sensing elements or light detectors for single scans at various platelet concentrations C. As noted above, the light detectors closer to the ends of the light detector array 20 tend to have a lower response, on account of receiving less light. As these peripheral light detectors tend to not provide much information regarding the nature of the subject fluid, analysis of the output signals may exclude the responses from the first and last N light detectors of the light detector array 20 without compromising the accuracy of the analysis. In practice, it has been found that excluding the first and last seven light detectors of a light detector array 20 has been suitable, though N may be any number without departing from the scope of the present disclosure. When the responses of N peripheral light detectors at each end of a light detector array 20 having 500 light detectors are excluded, the entire scan is adjusted downward by subtracting I_{R}(N+1), resulting in an adjusted scan I_{A}(p) given by Equation [1]:

I_{A}(p)=I_{R}(p)−I_{R}(N+1)N<p<(500−N), [1]

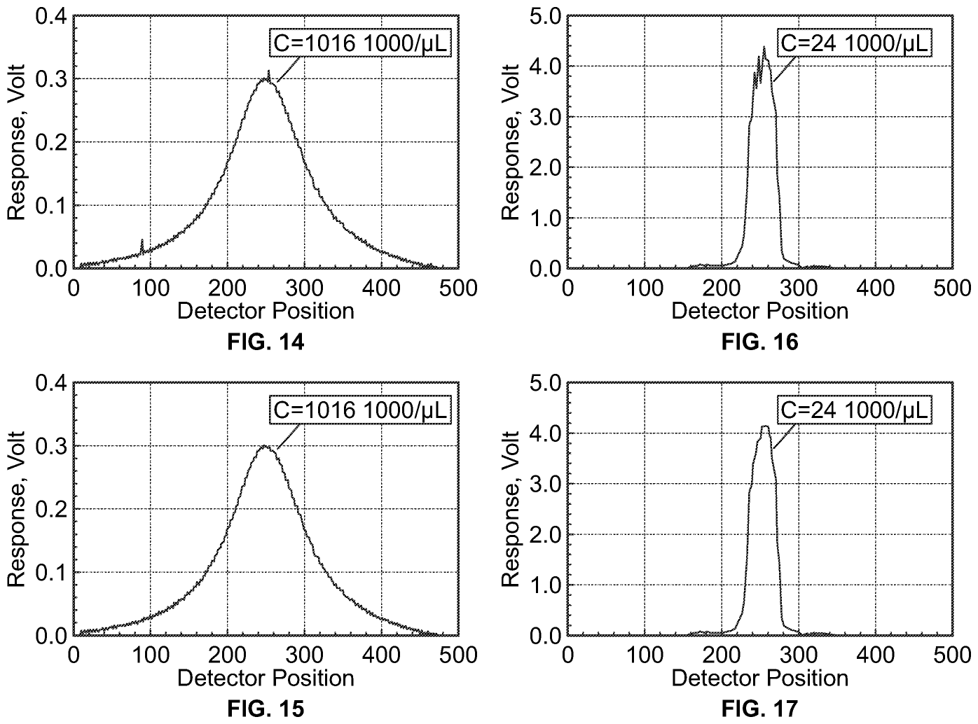

This adjusted intensity scan may be filtered to remove random spikes and smooth the intensity output. Different filtering techniques may be employed without departing from the scope of the present disclosure. In an exemplary approach illustrated in FIGS. 14-17, scans of a high concentration fluid F (FIG. 14) and a low concentration fluid f (FIG. 16) are subjected to a median filter to produce the filtered scans shown in FIG. 15 (for the high concentration fluid F) and FIG. 17 (for the low concentration fluid f). It will be seen that a median filter is effective for spike removal and smoothing, particularly for the low concentration fluid f illustrated in FIGS. 16 and 17.

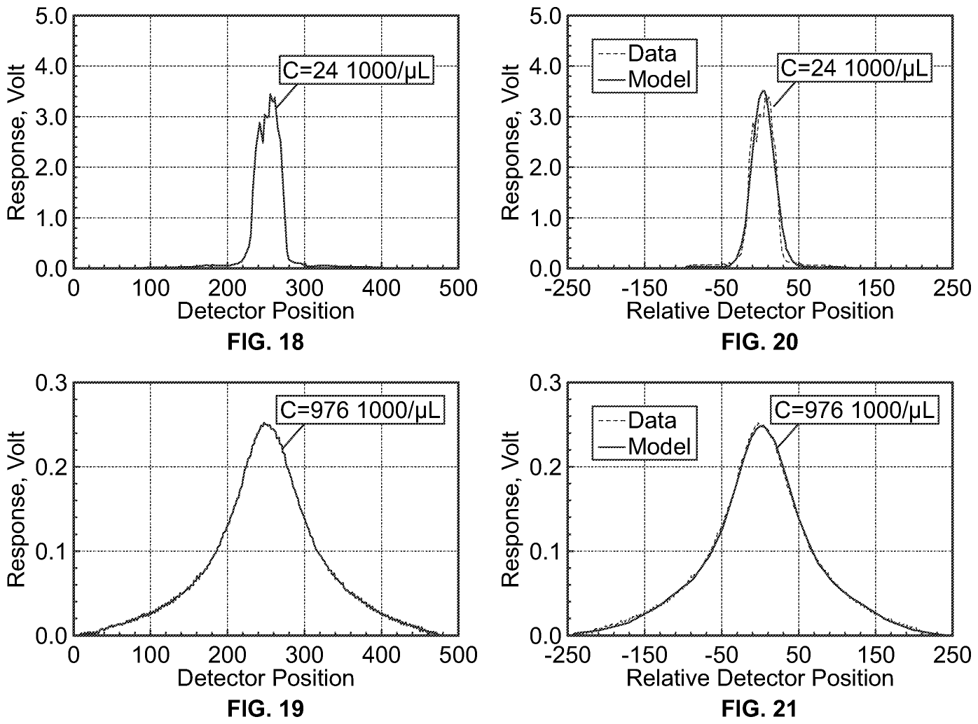

In addition to or instead of applying any of a number of possible filtering techniques, the data may also be smoothed by averaging multiple scans taken over a timeframe that is small compared to other system changes (notably, the composition of the fluid). FIGS. 18 and 19 show the results of averaging 1,000 scans (which may be taken over a timeframe of approximately 10 seconds) for low and high concentration fluids, respectively. FIG. 18 may be compared to FIG. 16, while FIG. 19 may be compared to FIG. 14 to see the smoothing achieved by averaging the results of 1,000 scans (FIGS. 18 and 19) instead of relying upon a single scan (FIGS. 16 and 14).

The fact that the smoothness of the light detector responses for the low concentration fluid f are not dramatically improved by averaging 1,000 scans suggests that the signal variability is due largely to the variability from detector to detector within the light detector array 20 rather than variability within an individual light detector from scan to scan. Such variability may be diminished by instituting a normalization procedure in which the entire light detector array 20 is exposed to a uniform light intensity IN and an intensity adjustment factor Z is assigned to each array element i, which may be calculated using Equation [2]:

$${Z}_{i} = \frac{{R}_{N}}{{R}_{{N}_{i}}} . \qquad [ 2 ]$$

A corrected response R_{C,i} is then calculated according to Equation [3]:

R_{C,i}=ZᵢRᵢ, [3]

in which Rᵢ is the uncorrected response.

Another approach to scan smoothing is to fit a function by non-linear regression to the scan data. Different approaches may be applied without departing from the scope of the present disclosure, though it has been found that the superposition of two normal distribution functions as shown in Equation [4] fits the data quite well in most cases:

$${I}_{A , FIT} ( p ) = {A}_{1} exp [ - \frac{{( p - {p}_{0} )}^{2}}{2 {S}_{1}^{2}} ] + {A}_{2} exp [ - \frac{{( p - {p}_{0} )}^{2}}{2 {S}_{2}^{2}} ] , \qquad [ 4 ]$$

in which A₁, A₂, S₁, S₂, and p₀ are fitting parameters. The results for the two datasets shown in FIGS. 18 and 19 are given in FIGS. 20 and 21, respectively.

Once a dataset has been processed, as desired, it may be used by the controller to analyze the subject fluid, though a relationship between the data and the characteristic(s) of interest must first be established. By way of example, let M be some property of the processed scan which is hypothesized to be a function ƒ of platelet concentration C. Thus:

M=ƒ(C), [5].

The appropriateness of Mas an indicator of C through the function ƒ is assessed experimentally by obtaining scans at various platelet concentrations, then fitting M to ƒ by regression, which yields values for various fitting parameters (p₁, p₂, . . . pₙ). Those parameters are then used to calculate a predicted value of C:

Cₚ=g(p₁,p₂, . . . pₙ,M), [6].

As a simple example, suppose M is the maximum intensity and ƒ(C)=p₁C+p₂, which represents a linear relationship with a non-zero intercept. Then, given these fitted values of p₁ and p₂:

$${C}_{p} = \frac{M - {p}_{2}}{{p}_{1}} , . \qquad [ 7 ]$$

Table 1 presents various exemplary equations defining M and ƒ(C):

TABLE 1
Data Analysis Methods

| Method | | | |
|---|---|---|---|
| Number | M | M = f(C) | C_{P} = g(p₁, p₂, . . . pₙ, M) |
| 1 | Intensity | M = p₁ exp(−p₂C) + p₃C + p₄ | Iterative solution required |
| | maximum, I_{MAX} | | |
| 2 | Sum (integral) of | ″ | ″ |
| | intensities, I_{INT} | | |
| 3 | Log₁₀(I_{MAX}) | ″ | ″ |
| 4 | Log₁₀(I_{INT}) | ″ | ″ |
| 5 | Absorbance using | M = p₁[1 − exp(−p₂C)] + p₃C | ″ |
| | I_{MAX}, A_{IMAX}(1) | | |
| 6 | Absorbance using | ″ | |
| | I_{INT}, A_{IINT}(1) | | |
| 7 | Scan width at | M = p₁ + p₂C | C_{P} = (M − p₁)/p₂ |
| | half-height, W₅₀ | | |
| 8 | ″ | $M = {p}_{1} + \frac{{p}_{2}}{1 + exp [ - \frac{( C - {p}_{3} )}{{p}_{4}} ]}$ | $\begin{matrix}{C}_{P} = {p}_{3} - {p}_{4} ln ( \frac{{p}_{2}}{M - {p}_{1}} - 1 ) \\ M < {p}_{1} + {p}_{2}\end{matrix}$ |
| 9 | ″ | $M = {p}_{1} + \frac{{p}_{2}}{1 + {( \frac{C}{{p}_{3}} )}^{{p}_{4}}}$ | $\begin{matrix}{C}_{P} = {{p}_{3} ( \frac{{p}_{2}}{M - {p}_{1}} - 1 )}^{\frac{1}{{p}_{4}}} \\ M < {p}_{1} + {p}_{2}\end{matrix}$ |

In Table 1, absorbance A is defined as

$$A = - {log}_{10} ( \frac{S}{{S}_{REF}} )$$

where S is either I_{MAX} or I_{INT} and S_{REF} refers to a reference scan at low (preferably zero) platelet concentration.

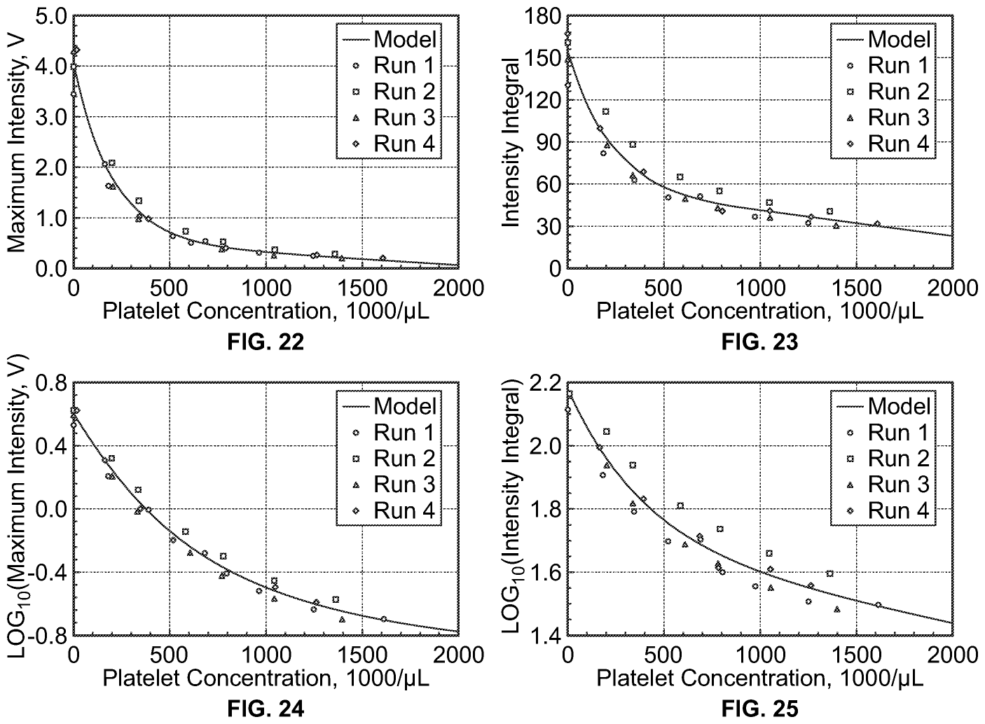

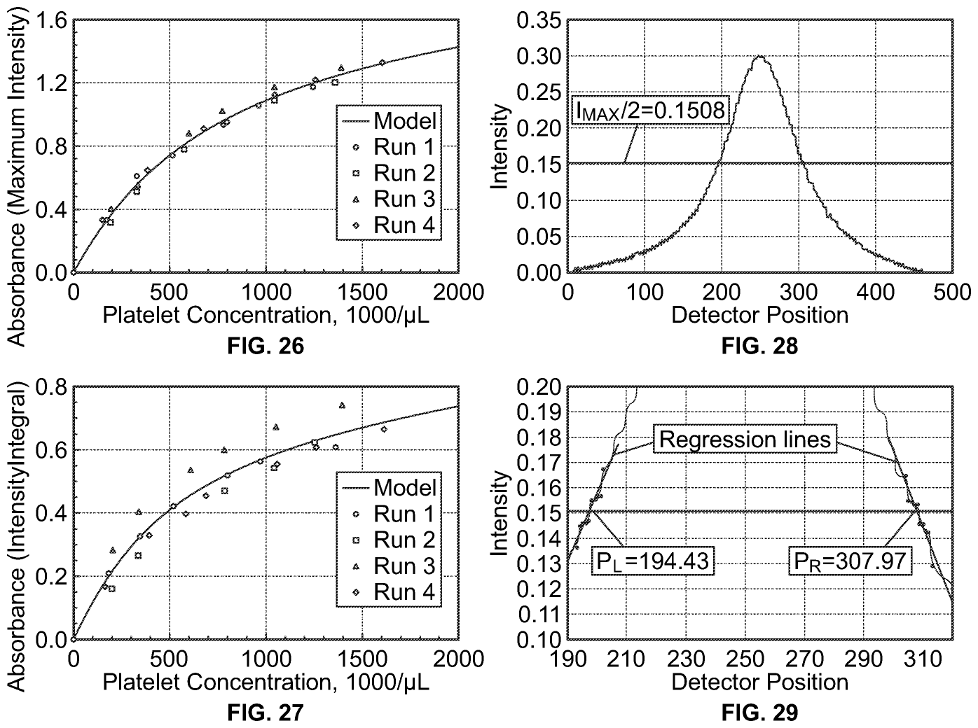

Methods 1-4 of Table 1 fit the data to a function which produces an initial exponential fall in M in the low concentration region followed by a linear decline at higher concentrations. FIGS. 22-25 show plots of data for a single test run and the corresponding fitted curves for Methods 1-4, respectively. Methods 5 and 6 fit the data to an initial exponential rise in the low concentration region followed by a linear increase at higher concentrations, with FIGS. 26 and 27 showing corresponding plots for these methods, respectively.

It will be seen that there is no closed form for the corresponding g function for Methods 1-6. Given the fitted parameters, a value of M, and an initial guess for concentration, C can be obtained iteratively. For example, it has been found that the Newton-Raphson method works very well for these functions, in which:

F=ƒ(p₁,p₂,p₃,p₄,)−M, [8].

Then:

$${C}_{i + 1} = {C}_{i} - \frac{F ( {C}_{i} )}{{F}^{′} ( {C}_{i} )} , . \qquad [ 9 ]$$

Methods 7, 8, and 9 are used to determine a fluid property (e.g., concentration of a substance, such as platelets) from the width W₅₀ of the scan curves at an intensity value equal to one half that of the maximum value I_{MAX,1/2}. A first order estimate of this value is obtained be traversing the intensity/data array from left to right (Positions 1 to 500 for a light detector array 20 having 500 individual light detectors) and identifying the first point on the left P_{L,i} at which the intensity is greater than I_{MAX,1/2} and the first point on the right P_{R,i} at which the intensity is less than I_{MAX,1/2}:

W₅₀=P_{R,i}−P_{L,i}, [10].

An improved estimation may be obtained by linear interpolation between the points P_{L,i} and P_{L,i-1} and between the points P_{R,i} and P_{R,i+1}. Still a further improvement may be achieved by performing a linear regression using points above and below P_{L,i} and P_{R,i} and then interpolating using the resulting slope and intercept. These techniques are illustrated in FIGS. 28 and 29, respectively.

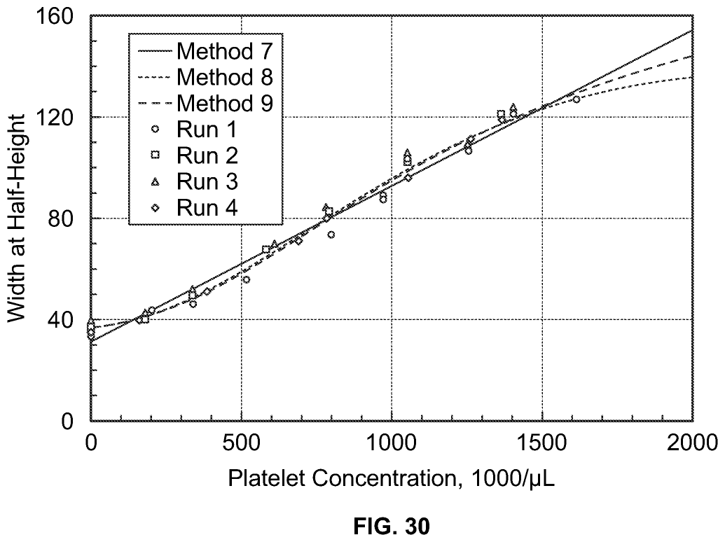

FIG. 30 shows the results when W₅₀ is calculated by the regression method and Methods 7, 8, and 9 are used to fit the data. Method 7 is a linear model and fits the data moderately well in the mid-range of concentrations. Methods 8 and 9 implement sigmoidal-shaped functions. While Methods 7-9 are described as measuring the width of light distribution at 50% of the maximum intensity, it should be understood that any other minimum percentage (e.g., 75% of the maximum intensity or 40% of the maximum intensity) may be selected without departing from the scope of the present disclosure. It will be seen that Methods 7-9 are based on the principle that, as cellular concentration increases, additional light scattering will occur, leading to an increase in the spatial distribution of transmitted light. Thus, measuring an increase in the width of light distribution at a particular percentage of maximum intensity may be interpreted as an increase in cell concentration.

Table 2 summarizes the results for prediction of platelet concentration based on the various methods:

TABLE 2
Summary of Platelet Concentration Predictions

| | | Average Absolute | Percentage of |
|---|---|---|---|
| | | Percent Maximum | points within |
| Method | Description | Deviation, % | ±10% |
| 1 | Maximum Intensity | 10.00 | 61.9 |
| 2 | Intensity Integral | 20.24 | 35.7 |
| 3 | LOG(Maximum Intensity) | 10.13 | 58.3 |
| 4 | LOG(lntensity Integral) | 20.37 | 33.3 |
| 5 | Absorbance using Maximum | | |
| | Intensity | 7.25 | 79.8 |
| 6 | Absorbance using Intensity | 19.34 | 45.2 |
| | Integral | | |
| 7, 8, 9 | Width at Half-height | | |
| 7 | Linear function | 9.51 | 69.1 |
| 8 | Sigmoidal function A | 8.65 | 72.6 |
| 9 | Sigmoidal function B | 8.15 | 73.8 |

It should be understood that these approaches to correlating light intensity to platelet concentration are merely exemplary and that other approaches may be employed (including being employed for determination of fluid characteristics other than platelet concentration) without departing from the scope of the present disclosure. Regardless of the particular approach that is determined to be the most appropriate based on the available data and the characteristic to be determined, the preferred approach may subsequently be employed by the controller when analyzing a subject fluid in a vessel V or conduit to determine the characteristic of interest of the fluid. It is also within the scope of the present disclosure for multiple methods to be employed to analyze a particular dataset, with the results of two or more of the methods being averaged or otherwise used in conjunction to determine a fluid property.

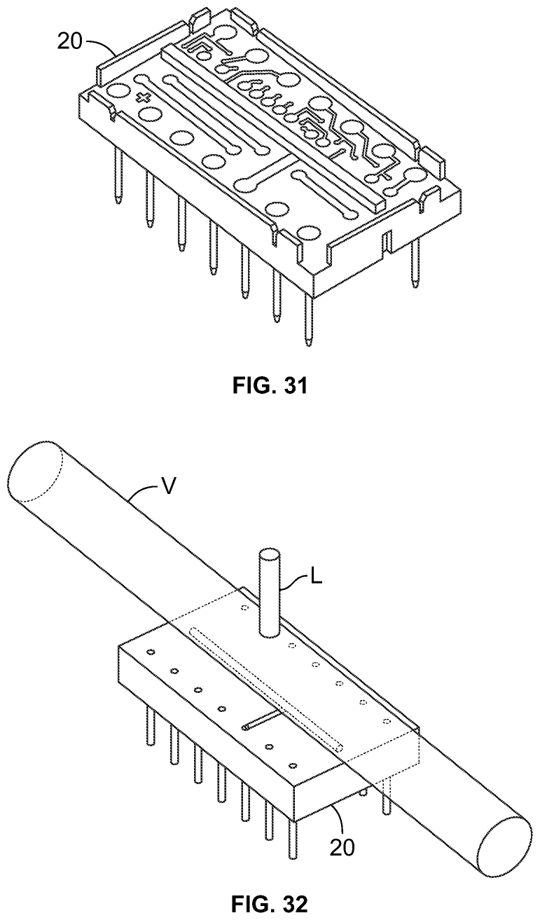

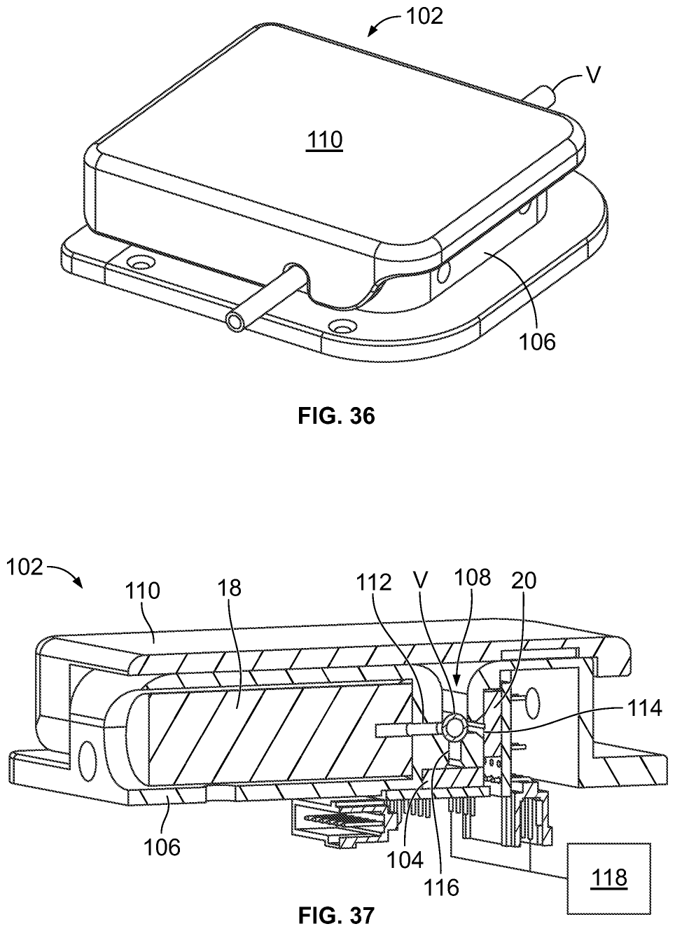

As noted above, the principles illustrated in FIGS. 11 and 12 are not limited to optical detection assemblies including a vessel attachment or vessel connector, but may be employed in a variety of differently configured systems. As also noted above, while FIGS. 11 and 12 illustrate the light detector array 20 as a transmission sensor positioned 180° from the light source 18 with respect to the vessel V, the light detector array may instead be configured as a side-scatter sensor positioned and oriented (e.g., 90° from the light source 18) so as to receive scattered light exiting the vessel V, with it is also being within the scope of the present disclosure for a pair of light detector arrays to be provided, with one serving as a transmission sensor and the other serving as a side-scatter sensor to allow for detection of both transmitted and scattered light exiting the vessel V. FIGS. 31-37 illustrate an exemplary optical detection assembly 102 employing a light detector array or components of such an assembly.

FIG. 31 illustrates an exemplary light detector array 20 that may be employed in an optical detection assembly 102 according to the present disclosure. The illustrated light detector array 20 is of the type marketed by arms AG of Austria as the TSL1402R linear sensor array, though differently configured arrays may be employed without departing from the scope of the present disclosure. FIG. 32 shows a fluid-containing vessel V positioned adjacent to the light detector array 20, with light L from a light source (not visible in FIG. 32) being directed toward the vessel V, with the array 20 being positioned and oriented so as to cause light transmitted through the fluid and vessel V to be received by the individual light detectors of the array 20 (thus making the array 20 a “transmission sensor”).

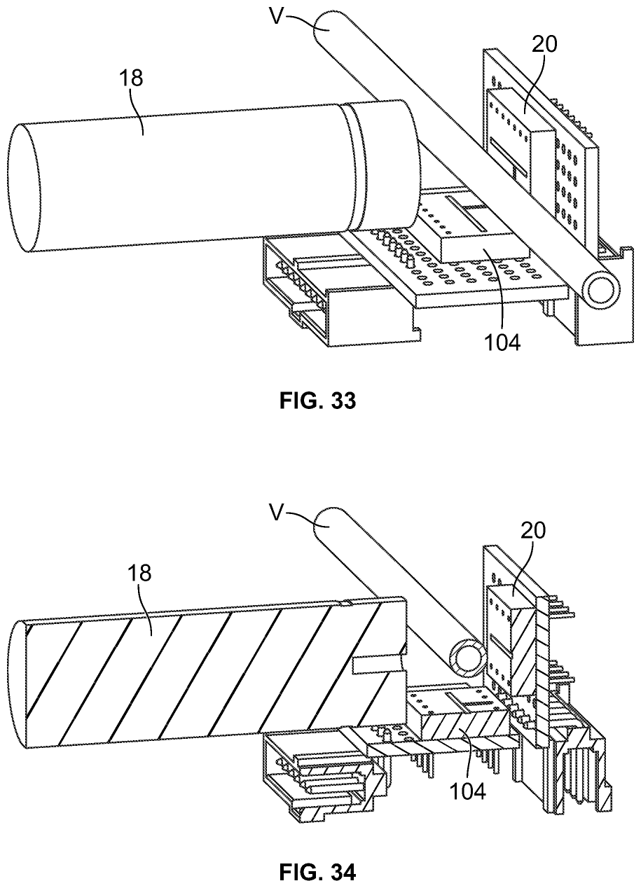

FIGS. 33 and 34 illustrate the transmission sensor 20, vessel V, and light source 18. A second light detector array 104 configured as a “side-scatter sensor” of the type described above is also provided, with the transmission sensor 20 positioned in-line with an axis of the light emitted by the light source 18 and configured to receive at least a portion of transmitted light exiting the vessel V and the side-scatter sensor 104 positioned at an angle with respect to the axis of the light emitted by the light source 18 and configured to receive at least a portion of scattered light exiting the vessel V. While FIGS. 33 and 34 illustrate the two sensors 20 and 104 as being substantially identical, it should be understood that they may be differently configured without departing from the scope of the present disclosure. As for the light source 18, it is illustrated as a laser, but it is contemplated that it may be differently configured (e.g., as a light-emitting diode), with the light source 18 being configured to emit light of any specific wavelength or combination of wavelengths. Additionally, while the side-scatter sensor 104 is shown as being positioned and oriented approximately 90° with respect to the axis of the light emitted by the light source 18, it should be understood that a different angle may be employed.

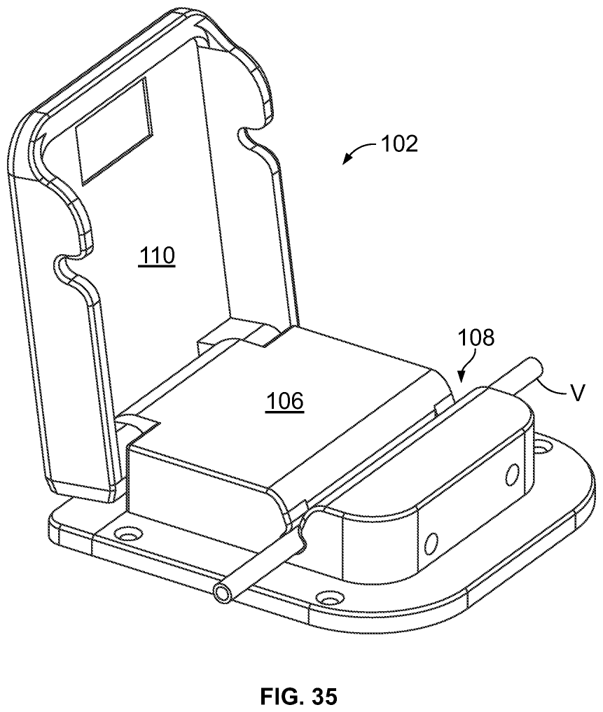

FIGS. 35-37 illustrate an optical detection assembly 102 incorporating the light source 18 and sensors 20 and 104 of FIGS. 33 and 34. The optical detection assembly 102 includes a base 106 defining a slot or channel 108 configured to receive at least a portion of a vessel V. The optical detection assembly 102 may also include a lid 110 (which is shown in FIGS. 34-36 as being hingedly or pivotally associated to the base 106) to block external light from interfering with analysis of a fluid in the vessel V.

The channel 108 is configured to secure the vessel V in a desired orientation with respect to the light source 18 and the sensors 20 and 104. As best shown in FIG. 37, the light source 18, the transmission sensor 20, and the side-scatter sensor 104 may each be positioned directly adjacent to the channel 108. In the illustrated embodiment, a first aperture 112 extends away from the channel 108 in the direction of the light source 18 to allow for light transmitted by the light source 18 to reach the vessel V within the channel 108. A second aperture 114 extends away from the channel 108 in the direction of the transmission sensor 20 to allow for transmitted light exiting the vessel V to reach the transmission sensor 20. A third aperture 116 extends away from the channel 108 in the direction of the side-scatter sensor 104 to allow for scattered light exiting the vessel V to reach the side-scatter sensor 104.

A controller 118 is coupled to the sensors 20 and 104 to receive signals from the individual light detectors of the sensors 20 and 104. The controller 118 is configured to receive signals from the sensors 20 and 104 and determine one or more properties of the subject fluid (e.g., the concentration of a substance in the fluid, such as platelet concentration) based on the signals from at least one of the sensors 20 and 104. In one embodiment, the controller 118 may be configured to determine one or more properties of the subject fluid based on signals from both of the sensors 20 and 104. The signals from the two sensors 20 and 104 may be used by the controller 118 to determine a single fluid characteristic or the signals from the transmission sensor 20 may be used by the controller 118 to determine a first fluid characteristic, while signals from the side-scatter sensor 104 may be used by the controller 118 to determine a second fluid characteristic. While a single controller 118 is shown as being associated with the two sensors 20 and 104, it is within the scope of the present disclosure for two controllers to be provided, with each controller configured to receive signals from a different one of the sensors 20 and 104.

### Aspects

Aspect 1. An optical detection assembly for monitoring a fluid in a vessel, comprising: a light source configured and oriented to emit a light into a fluid in a vessel; a light detector array comprising a plurality of light detectors and configured to receive at least a portion of the light exiting the vessel; and a controller configured to receive signals from the light detector array indicative of an intensity of said at least a portion of the light received by each one of said plurality of light detectors, and determine a concentration of a substance in the fluid in the vessel based at least in part on said signals.

Aspect 2. The optical detection assembly of Aspect 1, further comprising a second light detector array, wherein one of said light detector arrays comprises a transmission sensor positioned and configured to receive at least a portion of transmitted light exiting the vessel, the other one of said light detector arrays comprises a side-scatter sensor positioned and configured to receive at least a portion of scattered light exiting the vessel, and the controller is configured to determine the concentration of said substance in the fluid in the vessel based at least in part on signals from at least one of the light detector arrays.

Aspect 3. The optical detection assembly of Aspect 2, wherein the controller is configured to determine the concentration of said substance in the fluid in the vessel based at least in part on signals from both of the light detector arrays.

Aspect 4. The optical detection assembly of any one of Aspects 2-3, wherein the transmission sensor is positioned in-line with an axis of the light emitted by the light source, and the side-scatter sensor is positioned and oriented at an angle with respect to the axis of the light emitted by the light source.

Aspect 5. The optical detection assembly of Aspect 4, wherein the side-scatter sensor is positioned and oriented approximately 90° with respect to the axis of the light emitted by the light source.

Aspect 6. The optical detection assembly of any one of Aspects 2-5, further comprising a channel configured to receive at least a portion of the vessel and defining a first aperture associated with the light source and configured to accommodate at least a portion of the light emitted by the light source, a second aperture associated with the transmission sensor and configured to accommodate transmitted light exiting the vessel, and a third aperture associated with the side-scatter sensor and configured to accommodate scattered light exiting the vessel.

Aspect 7. The optical detection assembly of Aspect 1, further comprising a vessel attachment including substantially parallel first and second faces, wherein the first face of the vessel attachment is positioned facing the light source and oriented in a plane substantially orthogonal to a central axis of light emitted by the light source, the second face of the vessel attachment is positioned facing the light detector array, and the vessel attachment defines a cavity positioned between the first and second faces and configured to receive at least a portion of the vessel, with an outer surface of said at least a portion of the vessel in contact with an adjacent surface of the cavity at locations in which the light emitted by the light source is configured to enter the vessel and exit the vessel.

Aspect 8. The optical detection assembly of Aspect 7, wherein the vessel attachment is formed of a material having a refractive index substantially the same as a refractive index of a material forming the vessel.

Aspect 9. The optical detection assembly of any one of Aspects 7-8, wherein the vessel attachment is fixedly secured to the vessel.

Aspect 10. The optical detection assembly of any one of Aspects 7-9, wherein the vessel attachment is bonded to the vessel.

Aspect 11. The optical detection assembly of any one of Aspects 7-8, wherein the vessel attachment comprises first and second pieces each defining a portion of the cavity, and the first piece of the vessel attachment is at least partially movable with respect to the second piece of the vessel attachment.

Aspect 12. The optical detection assembly of Aspect 11, further comprising a first sensor housing associated with the light source and the first piece of the vessel attachment, and a second sensor housing movable associated with the light detector array and the second piece of the vessel attachment, wherein at least a portion of one of the sensor housings is movable with respect to at least a portion of the other one of the sensor housings.

Aspect 13. The optical detection assembly of any one of Aspects 7-12, wherein the cavity is substantially cylindrical.

Aspect 14. The optical detection assembly of any one of Aspects 7-12, wherein the cavity is defined by substantially parallel first and second cavity walls, and at least a portion of the first and second cavity walls are separated by a distance less than an outer dimension of said at least a portion of the vessel received by the cavity.

Aspect 15. The optical detection assembly of Aspect 14, wherein a first portion of the first and second cavity walls are separated by a first distance, a second portion of the first and second cavity walls are separated by a second distance, the first distance is different from the second distance, and each of the first and second distances is less than the outer dimension of said at least a portion of the vessel received by the cavity.

Aspect 16. The optical detection assembly of Aspect 15, wherein a third portion of the first and second cavity walls are separated by a third distance, the third distance is different from the first and second distances, and the third distance is less than the outer dimension of said at least a portion of the vessel received by the cavity.

Aspect 17. The optical detection assembly of any one of the preceding Aspects, wherein the light source is configured to emit collimated light.

Aspect 18. The optical detection assembly of any one of Aspects 1-16, wherein the light source is configured to emit diffuse light.

Aspect 19. The optical detection assembly of any one of the preceding Aspects, wherein the controller is configured to determine the concentration of the substance in the fluid in the vessel based at least in part on a maximum intensity of light received by one of said plurality of light detectors.

Aspect 20. The optical detection assembly of any one of Aspects 1-18, wherein the controller is configured to determine the concentration of the substance in the fluid in the vessel based at least in part on a summation of the intensity of light received by at least two of said plurality of light detectors.

Aspect 21. The optical detection assembly of any one of Aspects 1-18, wherein the controller is configured to determine the concentration of the substance in the fluid in the vessel based at least in part on the number of light detectors receiving light having an intensity of at least a minimum percentage of a maximum intensity of light received by one of said plurality of light detectors.

Aspect 22. The optical detection assembly of any one of the preceding Aspects, wherein the controller is configured to omit signals from selected light detectors when determining the concentration of the substance in the fluid in the vessel.

Aspect 23. The optical detection assembly of any one of the preceding Aspects, wherein the controller is configured to calculate an average of a plurality of signals from at least one of said light detectors when determining the concentration of the substance in the fluid in the vessel.

Aspect 24. An optical detection assembly for monitoring a fluid in a vessel, comprising: a light source configured and oriented to emit a light into a fluid in a vessel; a light detector configured to receive at least a portion of the light exiting the vessel; a vessel attachment including substantially parallel first and second faces, wherein the first face of the vessel attachment is positioned facing the light source and oriented in a plane substantially orthogonal to a central axis of light emitted by the light source, the second face of the vessel attachment is positioned facing the light detector, and the vessel attachment defines a cavity positioned between the first and second faces and configured to receive at least a portion of the vessel, with an outer surface of said at least a portion of the vessel in contact with an adjacent surface of the cavity at locations in which the light emitted by the light source is configured to enter the vessel and exit the vessel; and a controller configured to receive a signal from the light detector indicative of an intensity of said at least a portion of the light received by the light detector, and determine a concentration of a substance in the fluid in the vessel based at least in part on said signal.

Aspect 25. The optical detection assembly of Aspect 24, wherein the vessel attachment is formed of a material having a refractive index substantially the same as a refractive index of a material forming the vessel.

Aspect 26. The optical detection assembly of any one of Aspects 24-25, wherein the vessel attachment is fixedly secured to the vessel.

Aspect 27. The optical detection assembly of any one of Aspects 24-26, wherein the vessel attachment is bonded to the vessel.

Aspect 28. The optical detection assembly of any one of Aspects 24-25, wherein the vessel attachment comprises first and second pieces each defining a portion of the cavity, and the first piece of the vessel attachment is at least partially movable with respect to the second piece of the vessel attachment.

Aspect 29. The optical detection assembly of Aspect 28, further comprising a first sensor housing associated with the light source and the first piece of the vessel attachment, and a second sensor housing movable associated with the light detector array and the second piece of the vessel attachment, wherein at least a portion of one of the sensor housings is movable with respect to at least a portion of the other one of the sensor housings.

Aspect 30. The optical detection assembly of any one of Aspects 24-29, wherein the cavity is substantially cylindrical.

Aspect 31. The optical detection assembly of any one of Aspects 24-29, wherein the cavity is defined by substantially parallel first and second cavity walls, and at least a portion of the first and second cavity walls are separated by a distance less than an outer dimension of said at least a portion of the vessel received by the cavity.

Aspect 32. The optical detection assembly of Aspect 31, wherein a first portion of the first and second cavity walls are separated by a first distance, a second portion of the first and second cavity walls are separated by a second distance, the first distance is different from the second distance, and each of the first and second distances is less than the outer dimension of said at least a portion of the vessel received by the cavity.

Aspect 33. The optical detection assembly of Aspect 32, wherein a third portion of the first and second cavity walls are separated by a third distance, the third distance is different from the first and second distances, and the third distance is less than the outer dimension of said at least a portion of the vessel received by the cavity.

Aspect 34. The optical detection assembly of any one of Aspects 24-33, wherein the light source is configured to emit collimated light.

Aspect 35. The optical detection assembly of any one of Aspects 24-33, wherein the light source is configured to emit diffuse light.

Aspect 36. An optical detection assembly for monitoring a fluid, comprising: a light source; a light detector; a vessel connector including substantially parallel first and second faces and defining a first cavity configured to receive at least a portion of a first vessel, a second cavity configured to receive at least a portion of a second vessel, and a conduit extending from the first cavity to the second cavity and comprising substantially parallel first and second walls, wherein the first face of the vessel connector is positioned facing the light source and oriented in a plane substantially orthogonal to a central axis of light emitted by the light source, the second face of the vessel connector is positioned facing the light detector, the first and second walls of the conduit are substantially parallel to the first and second faces of the vessel connector, and the light detector is configured to receive at least a portion of the light emitted by the light source after said at least a portion of the light has based through the first face of the vessel connector, through the first wall of the conduit, through a fluid in the conduit, through the second wall of the conduit, and through the second face of the vessel connector; and a controller configured to receive a signal from the light detector indicative of an intensity of said at least a portion of the light received by the light detector, and determine a concentration of a substance in the fluid in the conduit based at least in part on said signal.

Aspect 37. The optical detection assembly of Aspect 36, wherein the first and second walls of the conduit are separated by a distance less than a diameter of at least one of the first and second cavities.

Aspect 38. The optical detection assembly of Aspect 36, wherein the first and second walls of the conduit are separated by a distance less than a diameter of each of the first and second cavities.

Aspect 39. The optical detection assembly of any one of Aspects 36-38, wherein the light source is configured to emit collimated light.

Aspect 40. The optical detection assembly of any one of Aspects 36-38, wherein the light source is configured to emit diffuse light.

It will be understood that the embodiments and examples described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. An optical detection assembly for monitoring a fluid in a vessel, comprising:
a light source configured and oriented to emit a light into a fluid in a vessel;
a light detector array comprising a plurality of light detectors and configured to receive at least a portion of the light exiting the vessel; and
a controller configured to
receive signals from the light detector array indicative of an intensity of said at least a portion of the light received by each one of said plurality of light detectors, and
determine a concentration of a substance in the fluid in the vessel based at least in part on said signals.

2. The optical detection assembly of claim 1, further comprising a second light detector array, wherein
one of said light detector arrays comprises a transmission sensor positioned and configured to receive at least a portion of transmitted light exiting the vessel,
the other one of said light detector arrays comprises a side-scatter sensor positioned and configured to receive at least a portion of scattered light exiting the vessel, and
the controller is configured to determine the concentration of said substance in the fluid in the vessel based at least in part on signals from at least one of the light detector arrays.

3. The optical detection assembly of claim 2, wherein the controller is configured to determine the concentration of said substance in the fluid in the vessel based at least in part on signals from both of the light detector arrays.

4. The optical detection assembly of claim 2, wherein
the transmission sensor is positioned in-line with an axis of the light emitted by the light source, and
the side-scatter sensor is positioned and oriented at an angle with respect to the axis of the light emitted by the light source.

5. The optical detection assembly of claim 4, wherein the side-scatter sensor is positioned and oriented approximately 90° with respect to the axis of the light emitted by the light source.

6. The optical detection assembly of claim 2, further comprising a channel configured to receive at least a portion of the vessel and defining a first aperture associated with the light source and configured to accommodate at least a portion of the light emitted by the light source, a second aperture associated with the transmission sensor and configured to accommodate transmitted light exiting the vessel, and a third aperture associated with the side-scatter sensor and configured to accommodate scattered light exiting the vessel.

7. The optical detection assembly of claim 1, further comprising a vessel attachment including substantially parallel first and second faces, wherein
the first face of the vessel attachment is positioned facing the light source and oriented in a plane substantially orthogonal to a central axis of light emitted by the light source,
the second face of the vessel attachment is positioned facing the light detector array, and
the vessel attachment defines a cavity positioned between the first and second faces and configured to receive at least a portion of the vessel, with an outer surface of said at least a portion of the vessel in contact with an adjacent surface of the cavity at locations in which the light emitted by the light source is configured to enter the vessel and exit the vessel.

8. The optical detection assembly of claim 7, wherein the vessel attachment is formed of a material having a refractive index substantially the same as a refractive index of a material forming the vessel.

9. The optical detection assembly of claim 7, wherein the vessel attachment is fixedly secured to the vessel.

10. The optical detection assembly of claim 7, wherein the vessel attachment is bonded to the vessel.

11. The optical detection assembly of claim 7, wherein
the vessel attachment comprises first and second pieces each defining a portion of the cavity, and
the first piece of the vessel attachment is at least partially movable with respect to the second piece of the vessel attachment.

12. The optical detection assembly of claim 11, further comprising
a first sensor housing associated with the light source and the first piece of the vessel attachment, and
a second sensor housing movable associated with the light detector array and the second piece of the vessel attachment, wherein at least a portion of one of the sensor housings is movable with respect to at least a portion of the other one of the sensor housings.

13. The optical detection assembly of claim 7, wherein the cavity is substantially cylindrical.

14. The optical detection assembly of claim 7, wherein
the cavity is defined by substantially parallel first and second cavity walls, and
at least a portion of the first and second cavity walls are separated by a distance less than an outer dimension of said at least a portion of the vessel received by the cavity.

15. The optical detection assembly of claim 14, wherein
a first portion of the first and second cavity walls are separated by a first distance,
a second portion of the first and second cavity walls are separated by a second distance,
the first distance is different from the second distance, and
each of the first and second distances is less than the outer dimension of said at least a portion of the vessel received by the cavity.

16. The optical detection assembly of claim 15, wherein
a third portion of the first and second cavity walls are separated by a third distance,
the third distance is different from the first and second distances, and
the third distance is less than the outer dimension of said at least a portion of the vessel received by the cavity.

17. The optical detection assembly of claim 1, wherein the light source is configured to emit collimated light.

18. The optical detection assembly of claim 1, wherein the light source is configured to emit diffuse light.

19. The optical detection assembly of claim 1, wherein the controller is configured to determine the concentration of the substance in the fluid in the vessel based at least in part on a maximum intensity of light received by one of said plurality of light detectors.

20. The optical detection assembly of claim 1, wherein the controller is configured to determine the concentration of the substance in the fluid in the vessel based at least in part on a summation of the intensity of light received by at least two of said plurality of light detectors.

21. The optical detection assembly of claim 1, wherein the controller is configured to determine the concentration of the substance in the fluid in the vessel based at least in part on the number of light detectors receiving light having an intensity of at least a minimum percentage of a maximum intensity of light received by one of said plurality of light detectors.

22. The optical detection assembly of claim 1, wherein the controller is configured to omit signals from selected light detectors when determining the concentration of the substance in the fluid in the vessel.

23. The optical detection assembly of claim 1, wherein the controller is configured to calculate an average of a plurality of signals from at least one of said light detectors when determining the concentration of the substance in the fluid in the vessel.

24-40. (canceled)
